(19) United States
(12) Patent Application Publication
(10) Pub. No.: US 2005/0219366 A1
(43) Pub. Date: Oct. 6, 2005

(54) Digital audio-video differential delay and channel analyzer

(76) Inventors: Richard R. Hollowbush, Fleetwood, PA (US); Kenneth S. Altschuler, Pottstown, PA (US); Ed Brosz, King of Prussia, PA (US); Carl Cochrane, West Chester, PA (US); David R. Guerrero, Center Valley, PA (US); Douglas Lang, Cheltenham, PA (US)

Correspondence Address: DUANE MORRIS, LLP;IP DEPARTMENT, ONE LIBERTY PLACE, PHILADELPHIA, PA, 19103-7396, US

(21) Appl. No.: 10/813,814

(22) Filed: Mar. 31, 2004

(51) Int. Cl. H04N 17/02

(52) U.S. Cl. 348/193; 348/184

(57) ABSTRACT

A testing device and method for a digital video processing system is coupleable to an input and output of the processing system, and inserts video and audio marking information into the input to test system operation. The test device inserts a video marker and an audio marker data code for a single audio channel, preferably in the same digital input frame. The device then monitors the same audio channel and also all the other audio channels at the output, while monitoring for the video marker. The device indicates the occurrence and timing of results that appear at the outputs, the relative timing of the output audio mark(s) versus the video mark, an alarm in the event that an output mark is not found or found on an unexpected channel, etc. The test device successively exercises the audio and video portions of the processing system while also providing numeric timing measurements that are useful for proper setup and operation.

### FIELD OF THE INVENTION

The invention relates to test apparatus and methods for analyzing digital systems capable of processing multiple audio channels, in particular digital audio/video devices wherein a device processes video signals, together with audio signals on plural channels.

An inventive test apparatus embeds marker data into a digital signal applied as an input to an audio/video device under test. Proceeding one channel at a time in a sequence, for example, the apparatus marks the active video signal and contemporaneously marks one of several audio channels. The test apparatus then monitors plural channel outputs of the device under test for appearance of corresponding data, determining audio/video lead or lag time from the timing of emergence of the video and audio data markers, and also detecting any audio channel mismatch as revealed by emergence of the audio mark data on a different channel from the channel marked at the input.

### PRIOR ART

It is known when processing a signal through successive stages of encoding, decoding or other processing, that delays occur. Any processing delay causes the output to lag the input by some time delay, and longer or shorter delays might occur in different situations. For example, one or more amplifiers processing an analog signal may introduce a delay. A succession of shift registers or other buffer memories may introduce a delay in a digital device. In the case of an amplifier, the delay might amount only to a phase difference between the output and the input. In the case of a shift register or memory, the delay might short or might be substantial.

A delay that causes an output of a device to occur somewhat later than the input, may be unimportant, for example, if the occurrences at the output are not referenced to occurrences at the input. In such a case, if the signal is repeated intact at the output at some time after the signal was received a the input, and there is no reference to the timing at the input, the delay is not noticeable. An example of such a situation could be one in which a digital signal is assembled and accumulated from packets or other parts that are received discontinuously and stored in a buffer from which the signal is read out. The output can be made to occur continuously, by delaying for a period that is longer than any gaps that may have occurred during the discontinuous reception.

In specific connection with video programs, attention is paid to dealing with the signal in one or both of frames or fields. Any switching from one video signal to another is advantageously effected at a point in time between video frames (i.e., at the beginning or end of a frame or field) so that horizontal and vertical deflection circuits of television receivers that are displaying the picture portion of the signal can continue operation without the need to re-synchronize to a new starting reference for the frame, which could cause a disruption and flicker in the display.

Assuming that two switched sources are not previously synchronized, then one source being switched can be as much as a full frame out of synch with the other frame. Frame synchronizers are known in video switching apparatus, comprising a frame buffer or memory that can store one or more frames of video and read the signal out after a variable delay. The delay is set so that a scanning reference point (such as the vertical blanking interval) for the retarded signal is held and read out again so as to correspond in time with the same scanning reference point in the other signal. This permits the output signal to be switched from one input signal to another, which input signals are not synched, without causing a discontinuity or other disruption in the raster scanning of the output.

When switching between two different audio sources, there is no inherent subdivision in the audio that is comparable to a field or frame of video, although it is advantageous if the audio signal can remain associated with the video signal with which the audio was encoded. If the relative time displacement of the audio signal is small, however, such as the fraction of a second in which a frame synchronized switch might delay a frame of video, the relative time displacement of the audio and the video is so short as to be unnoticeable to the viewer. As a result, it may be acceptable to switch an audio output directly from one input signal to another even though the audio is associated with a video signal that is being delayed by buffering for up to a video frame. When such a switching event occurs, the audio and the video portions of a signal become only trivially separated in time.

U.S. Pat. No. 5,243,424—Emmett teaches that audio-late delays of 40 mS and video-late delays of 20 mS are near the threshold of what is perceptible to a human viewer. The patent teaches inserting a predetermined frequency beep tone into an audio signal accompanied by a video signal, detecting the beep tone at a bandpass filter after the audio and video signals pass along different signal paths, and inserting a variable delay into the audio or video signal path in an effort to counteract the difference. In order to address the fact that distracting audible beep tones may be heard in an audio program, the volume of the beep tone is kept to a minimum, while hopefully being strong enough to be detectable by filtering. This solution has some practical challenges.

Audio/video timing differences can be introduced by the relatively slow propagation of sound waves in air, compared to the much quicker propagation of light. In US publication 2003/0193616—Baker et al., the situation is addressed in which an outdoor audio/video program such as a golf match is recorded using a number of video cameras. Some of the cameras are mobile, and the different cameras are spaced by widely different distances from the action. In this case, for managing variable audio delays, a concealed “watermark” is imposed on the video part of the signal to distinguish the particular video camera from others and to allow management of different audio delays for the different signal sources.

In connection with digital signal processing, there are similar situations in which buffering or processing delays can cause corresponding audio and video portions of a program to become separated in time by passing along different signal transmission or processing paths. This problem is addressed in U.S. Pat. No. 6,414,960—Kuhn et al., which involves broadcast network distribution of compressed audio/video signals. An effort is made to hold back and buffer the processing of the audio and the video portions so that both can be read out again continuously and their original timing relationship.

The foregoing patents concern delays in routine signal paths, but do not concern the particular problems of video production and test equipment, and do not help with problems that arise in connection with having a number of audio channels.

Depending on how the signal and its different audio and video data portions are processed, the delay can differ for different portions of the signal, including potential processing time differences among the respective audio channels. Such delays tend to become noticeable. For example, a substantial relative delay in certain channels of a multi-channel audio program could sound like an echo. A relatively shorter delay may produce phase interference effects. It would be advantageous to sense for such delays potentially to assist in troubleshooting and possibly to enable the insertion of a compensatory delay where needed.

In digital video systems, the displayed output may not be as closely linked to the timing of a raster scanned display. Digital video systems may have non-interlaced displays instead of interleaved fields. The display screen can be controlled by a processor that stores color information in one or more image memories from which an image is read out by a display driver. The involvement of a processor could enable such digital systems to accomplish various picture data processing steps. Examples include, for example, numeric data processing of video color data, resizing, pattern generation, superimpositions, pattern recognition, etc. Any processing time associated with such steps can delay the video portion of the signal. Advantageously, processing that results in discontinuous processing or signal retardation is offset by providing a sufficient buffer of memory to permit the output signal to be continuously read out even if the input processing was not so continuous.

Industry standards for digital video program signals have provisions made for encoding video data as well as audio, informational and other data. The stream of digital data has a portion used for marking the start and stop of video, a portion for video data samples, and a portion for audio and auxiliary data. It is advantageous if the audio portion that was encoded in connection with a video portion at a particular point in time, remain associated with the video portion.

In serial digital video and in high definition video, the digital encoding standards that allow audio and video information to be carried in the same data words or packets generally enable audio data to be carried along with corresponding video data through various buffering events. Delays can occur, however, such as where different processing steps are undertaken. Additionally, serial digital standards enable the nominally synchronous processing of a number of channels of audio and ancillary data together with video data. As a result of audio and video processing steps, there are opportunities for delaying the audio or video relative to one another, differentially delaying one or more of the audio channels relative to another for effect, and processing the data contents of certain audio channels in determining the playback data to be employed on other channels.

Thus, a digital receiver or entertainment center may routinely have the capability to process multiple audio channels. Considering only the video program, a surround sound arrangement may involve five audio channels. Processing capabilities may be provided to generate a surround sound effect from more or fewer than five channels, leading to channel mixing possibilities. In order to accommodate auxiliary inputs and multiple selectable sources of video and/or audio, additional channels can be involved. And furthermore, the use of a number of audio speakers in surround sound and similar entertainment systems is such that a even relatively minor delays that may have been irrelevant in an analog system with a frame synchronizing buffer of one frame, are now sufficient delay to produce noticeable audio effects.

What is needed is a way to deal with audio delays, audio coupling and other occurrences that are specific to digital audio channels. It would be advantageous in a digital audio test apparatus for signal processing that has the capability to process multiple channels, whether surround sound or switched inputs or processed signal paths, to better facilitate the testing and interaction of multiple audio channels. The present invention is specifically adapted to these ends.

### SUMMARY OF THE INVENTION

An object of the invention is to provide a device and method thoroughly to exercise, test and document the operational and timing effects of processing a digital audio-video signal through a processing device, in an optimally convenient and non-intrusive way, preferably using alternative display configurations presented on a test display presentation resembling a multi-channel volume display.

It is also an object to provide an input signal to an audio-video processing device with variations that are sufficient to exercise numerous possible relationships of inputs to outputs, to clearly indicate such relationships, and assuming that the processing device includes a receiver or other device that can play back the outputs, to cause the receiver to demonstrate such relationships.

These and other objects are met according to the invention by a testing device and method for a digital video processing system that is coupleable to an input and output of a processing system under test, and inserts video and audio marking information into the input to test system operation. The test device inserts a video data marker into active video, and an audio data marker into the data of an audio channel, preferably one channel at a time being marked with a distinct code. The video and the audio are marked by codes having a predetermined timing relationship such as codes inserted at the same time in an video frame. The inventive device then monitors the same marked audio channel and also all the other audio channels at the output, for emergence of the video and audio marker code. The device indicates the occurrence and timing of results that appear at the outputs, the relative timing of the output audio mark(s) versus the video marker, an alarm in the event that an output data marker is not found or found on an unexpected audio channel, etc. The test device successively exercises the audio and video portions of the processing system while also providing numeric timing measurements that are useful for proper setup and operation.

### BRIEF DESCRIPTION OF THE DRAWINGS

A number of additional objects and aspects are apparent from the appended description and the associated illustrations of preferred embodiments, wherein:

FIG. 1 is a schematic illustration of a test apparatus according to the invention, coupled to a generically-illustrated system under test and having an associated receiver.

FIG. 2 is a mapping illustrating aspects of one possible format for digital video programs including digital audio, as an example.

FIG. 3 is a timing diagram showing a sequence of test operations according to the invention.

FIG. 4 is a schematic diagram showing an exemplary logic diagram for determining a timing difference between audio and video markers.

### DETAILED DESCRIPTION

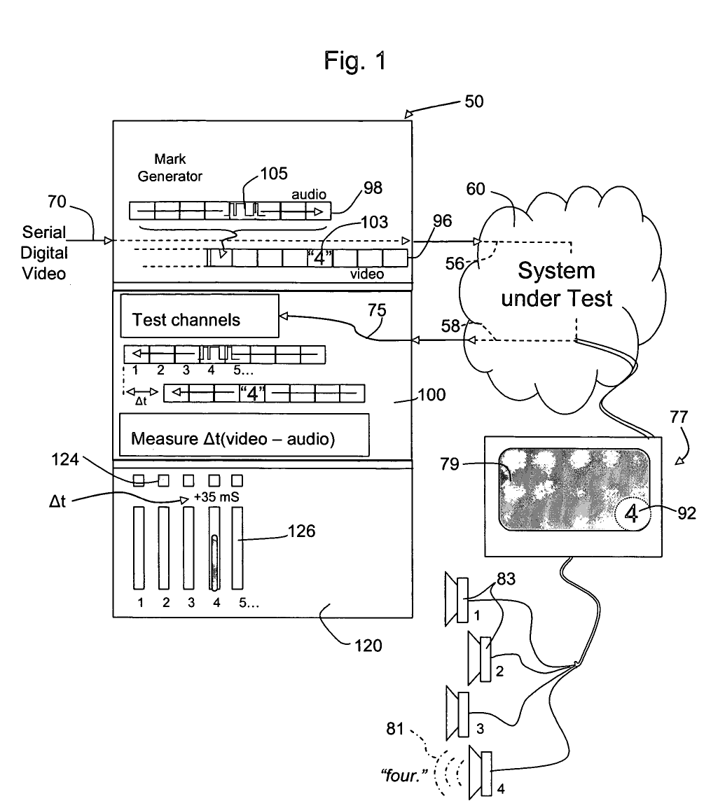

Referring generally to the block diagram in FIG. 1, a testing apparatus 50 and method for a digital video processing system are illustrated in schematic form. The testing apparatus 50 is coupleable to an input 56 into and output 58 of an arbitrary system 60, namely a system under test that is capable of processing a digital video signal with included audio data for plural channels. The system 60 under test could be any of various devices intended to record, transmit, playback, mix, alter and/or otherwise to perform operations based on the data found in a digital video signal, in this case illustrated as a serial digital video signal 70. The invention is also applicable to other data flow configurations such as operations on wholly or partly parallel successive data in a series-parallel configuration, processing of stored or compressed files, etc. The system under test has at least some operational modes that place onto the output 58 a representation of an audio/video signal that was received at the input 56, and the timing and integrity of this operation is the subject matter being tested according to the invention.

The testing apparatus 50 is coupleable to the input 56 leading into the system 60 under test, so as to provide a signal that the system 60 will process in the same manner that the system 60 otherwise processes video and audio signals in the normal course of business, i.e., when not being tested. In addition to making certain tests and measurements, the testing apparatus 50 of the invention operates in part to exercise the system 60 under test.

In order to assess the operation of the system 60 under test, in addition to applying a known input signal to input 56, the test apparatus 50 is coupled to a corresponding output 58 of system 60 so as to enable assessment of the operation of system 60, namely by comparing the output signals generated by the system under test to what is expected as nominal based on the input signals that the test apparatus 50 has applied. The signals at the input 56 and at the output 58 are preferably both in a same or similar format such as a standard serial digital format; however a change in signal format between the input and the output, or a non-standard format, could be handled in a manner similar to that described herein. The system under test additionally (or alternatively) can produce an output applied to one or more further devices that are downstream along the signal path, such as receiver 77, shown in FIG. 1. According to the invention, this output of the system under test is coupled back as a monitoring input 75 to the test apparatus 50. The test apparatus applies both a video signal portion 96 and an audio signal portion 98 to the system 60 under test.

The test apparatus 50 advantageously is used with a system 60 that has an associated receiver 77 so as to produce a perceptible output in response to test signals, namely in a familiar visual and audible form when the system 60 being tested is exercised. Therefore, advantageously, video data preferably is displayed on a monitor screen 79 or the like and acoustic signals 81 can be played out by speakers 83, in addition to the timing and integrity tests and measurements discussed herein. The speakers 83 are separately controllable so that audio signals inserted into the input signal can be addressed via distinct channels to corresponding speakers as output devices. The speakers also typically correspond to channels that are marked by insertion of marking data according to the invention.

The system 60 under test also can be exercised and analyzed without actually producing the video picture and audio marks that are used in the analysis, as outputs on a monitor 77. Similarly, a monitor apparatus that does not have all the output capabilities shown could also be used.

The system 60 under test is presumed to possibly have any arbitrary element or combination of elements that function as processing stages, mixers, recorders, playback devices, effects processors, etc. Apart from exercising various capabilities of such devices, it is an aspect of the invention that the audio timing characteristics and the audio channel input-to-output correspondence between the input 56 and the output 58 of the system 60 under test are examined. This is accomplished in a programmed manner by applying an input signal to each audio signal path, preferably with the capability to proceed separately one input channel at a time, and monitoring for the results on the same and other audio channels. Furthermore, any differential timing delay between the transit time of the video and audio signal portions 96, 98 is determined, measured and/or indicated.

Referring to FIG. 1, the test apparatus 50 inserts audio mark information 105 into the audio portion 96 of the input 56 to system 60. At a related time, preferably simultaneously, the test apparatus 50 inserts a corresponding marker 103 into the video signal 98. The respective times of onset of the audio mark 105 and video marker 103 provide timing references. In an embodiment including a monitor 77, a video display characteristic 92 and an associated audio signal can be caused to persist for a time, whereby a person monitoring receiver 77 can witness the progression of the test by seeing the video channel marker 92 in association with hearing the audio signal 81. However, the timing and integrity check also can proceed simply from triggering signals associated with insertion and subsequent detection of marker codes in the audio data associated with a channel and in the active video portion of the signal. The test proceeds through one or more of the addressable audio output devices 83 (e.g., speakers).

In FIG. 1, the test device 50 inserts a video marker code 103 and audio mark data 105 for a single audio channel, the example showing use of channel “4”. The video marker and the audio mark data can be caused to persist for a predetermined interval, for example one second, per channel, but the timing relationship between the audio and video portions need a discrete marking point in time. Preferably this is the commencement of the two marker signals if caused to persist. The markers in the active video and in one or a subset of the audio channels can be caused to occur, for example, at the beginning of a digital input frame or at a point in processing of data samples, such as a particular horizontal line, in either case functioning as timing start and stop signals, the time spacing of which is the differential audio-video delay that is produced by the system 60 under test.

The preferred embodiments of test apparatus 50 cycles through a series of tests of individual channels, i.e., applying an input to one audio channel (or perhaps a subset of the available audio channels) and inserting a video marker at the same time, then at least monitoring for the results on the expected channel in the output 58 and preferably all the other channels as well. Optionally, perceptible signals can be produced as well on an associated receiver 77 if available.

It is also possible to test multiple channels at once using two or more distinguishable mark signals at the same time or at different times. The test apparatus may have multiple test functions, one being simply to exercise the output channels. However, according to an inventive aspect, in addition to exercising the audio and determining the differential audio-video delay time, another function of test apparatus 50 is to determine whether the distribution of audio channel data that is caused to appear on the output from the system 60 under test corresponds to the distribution of data on the inputs, that is, to determine whether an input addressed for a particular channel appears on the output addressed for the same channel. Testing the integrity of channel handling in this way could potentially be accomplished using two or more distinguishable audio mark signals, but preferably is done by exercising the input channels one at a time, proceeding to a next channel after completing the processing of a test signal applied to a previous channel.

After applying a video mark code 103 and audio mark code 105 to the input 56 to the system 60 under test, the test device 50 of the invention monitors the video portion of the output 58 of the system under test for occurrence of the video marker, which serves as one of two timing references, and monitors the audio portion of the output for commencement of the audio marker. The time difference At, and an indication of which of the video and audio lagged the other are then read out on a display screen 120 or similar output device.

In monitoring the signal on the output 58 for occurrence of the inserted audio mark data 105, the inventive test apparatus 50 monitors the same audio channel at which the audio mark was inserted (channel “4” in the example), but preferably also monitors some or advantageously all of the other audio channels at the output 58 of the system under test. The test apparatus indicates not only the timing of results that appear at the outputs 58 of the system under test, but also any anomalies discovered in the correspondence of outputs and inputs. The indicated results show the relative timing of the output audio mark(s) versus the video marker, namely the time difference Δt and an indication of whether the mark or the video marker was leading or lagging the other (e.g., by indicating that Δt is positive or negative). If the audio mark is found to occur on a channel other than the one into which the mark was inserted, an alarm marker 124 or other indication can be presented in the output. In the example shown in FIG. 1, the timing indicator shows the delay time and lead/lag order, whereas the alarm 124 can be activated when necessary to show that the received audio output was found to contain the audio marker on a different channel (“2”) from the input (“4”), and preferably to identify the channel where the mark was found.

By proceeding through a succession of test cycles, test device 50 exercises each of the audio channels by addressing a different channel in audio data 96, and for each channel inserts marker 103 in the video portion of the signal to serve as a timing reference. The result is a series of numeric timing measurements that are useful for proper setup and operation.

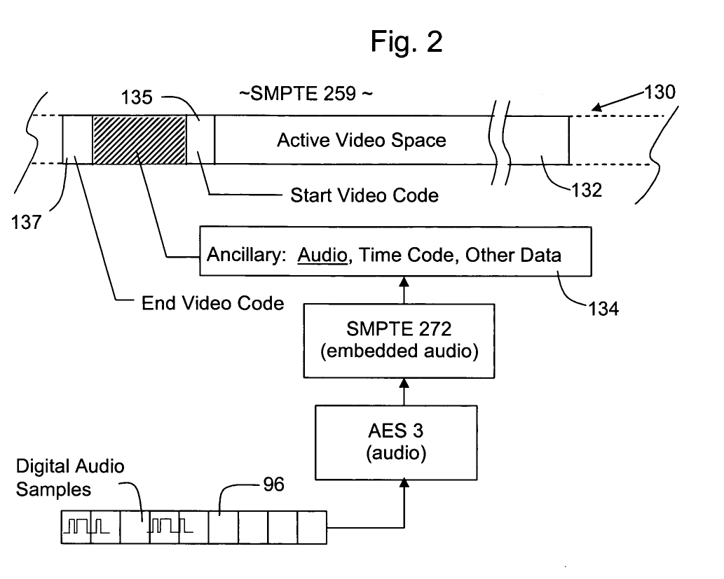

FIG. 2 is a plot showing the nature of a digital video signal, for example according to an exemplary standard for digital video, SMPTE 259. (It should be appreciated that this standard and the other standards mentioned in this disclosure are intended to represent non-limiting examples.) The exemplary signal 130 contains digitized video 132 and audio 134 information, typically in the form of a block of numeric samples transmitted one after another along the data path. The video portion occupies a larger proportion of the data stream, containing successive samples of color information that define individual pixel color states in the display. The video portion is delineated by start and stop codes 135, 137. At a reserved area between successive blocks 132 of video data, an ancillary data area is reserved and can contain audio that is embedded according to SMPTE 272, or AES3 audio, etc. The reserved ancillary data area can include other data besides audio data, such as control data, a time code and the like. However the area available at least includes space 134 for storing digitized audio sample data for a plurality of audio channels. In FIG. 2 the digital data is schematically indicated by sinusoids in repetitive channel slots. The actual digital data is numeric amplitude samples that, when applied to a digital to analog converter and amplifier (not shown) produce the necessary audio frequency marks to drive speakers 83 or the like as shown in FIG. 1. There are various other ways that video and multiple channel audio data might be mapped, and these standards are merely exemplary.

The ancillary data in the serial digital format in FIG. 2 could contain audio data for a Surround Sound system, namely with a center channel, sometimes a channel for low frequency effects, and a front and a rear channel for each of the left and right side, totaling five or six channels. Many applicable signal format standards can accommodate more than five or six channels. Thus there is a capability, for example, to carry two or more selectable audio signals on the digital signal path. For example, a particular arrangement might have user-selections such as a choice of audio tracks having dialogue in two or more languages, an optional channel mixing capability or to serve some other use. For example, the audio may accommodate eight or sixteen channels.

Each video sample defines several values that are decoded as the color parameter values of a discrete point or pixel in the image. An example is a luminance-and-color-difference sampling arrangement wherein each pixel is determined from a luminance value and one of two color differences for a given single data sample, the other color difference being provided from a neighboring sample containing a new luminance value and the other color difference. This information can be intended to produce a scanning raster display in an interlaced succession of fields that together form frames, for example by digital to analog conversion for operating an NTSC or PAL receiver. The information likewise might be intended for a non-interlaced display. Instead of producing a signal for driving a raster scanning receiver, the data can be used to populate the contents of an image memory that is coupled to a display driver. These provisions can be used for the video and audio signal itself, and the invention also can be embodied to include a display generator and controller that produces the visual output information presenting the results of tests, by populating a display memory or by coupling the necessary data to an outside display generator (not shown) that generates a video output with graphics and the like, e.g., in VGA, XGA or some other format, so a to drive a display screen to resemble the meter-like readouts shown in the drawings. These conventional video output details are not shown in the simplified schematic drawings.

Each audio sample digitally defines an instantaneous amplitude of a signal on one of the audio channels. The audio samples can be provided, for example, at a sampling rate of 48 KHz, each sample comprising twenty bits. Other specific sample sizes and rates are likewise possible. The marker code used can comprise an unlikely data code or a data code that persists for a predetermined succession of samples, etc.

The test apparatus 50 can produce a source of an audio-video program signal in a digital format having successive samples of video data and accompanying audio data for plural audio channels, the source being coupleable to an input of the system under test. Alternatively, an available program signal can be used for the audio-video program contents in this case and coupled as the input 70 to the test apparatus 50 such that when inserting a video data marker 103 and an audio data marker 105 as shown in FIG. 1, the test apparatus superimposes the video marker and the audio marker on the program contents that are present. If an internally generated content is preferred, test apparatus 50 can read out a blank picture or a test pattern, and silence or a background that is distinct from the marker for audio signals. The distinct video marker and inserted audio mark are superimposed on the blank and/or background content.

The audio-video test apparatus 50 of the invention can form an operational part of an apparatus having various functions that are useful in video production and other environments. In that event, it is advantageous to provide test signals such as color bar test patterns, audio exercise programs containing one or more tones or chirps panning through a frequency range, etc., as selectable modes of test operation.

According to the invention, an audio mark generator and a video mark generator are included in the test apparatus 50 as shown in FIG. 1. These generators produce audio test mark data and a corresponding video marker code for insertion into the video data stream applied to the system under test. Inasmuch as the signal is digital, however, the device need not operate an oscillator or produce an audio tone output. A tone can be inserted if desired to produce an audible output, by copying a stored data pattern representing an audio tone. The audio marker codes are likewise inserted by copying the code used as the marker into the data stream corresponding to the channel being tested. The timing measurement and channel integrity test can rely wholly on marking the data on the audio channel with a detectable pattern.

The audio exercising signal can include a succession of audio amplitude samples at a standard audio test frequency, such as a 997 Hz. This frequency is useful to avoid harmonics related to the 48 KHz audio sampling frequency. In an exemplary embodiment, the audio channels are tested and exercised one at a time, leaving sufficient time between testing of channels that any signal resulting from an input applied to a given audio channel as the active input, has died away before a different active channel is used for testing. It would be possible, to provide multiple test codes and exercising frequencies that can be distinguished.

The video marker data has a timing aspect needed when determining the differential timing characteristics of the system under test as described. In particular, the onset or first appearance of the video marker data 103 in the signal applied to input 56 to system 60 is a discrete timing reference point. The appearance of the audio mark data is also a discrete timing reference point. It is likewise possible to use a different defined reference point such as the end of a sustained repeated audio mark code or repeated video marker, or a change in the state of one or the other of these codes.

In keeping with the objectives to exercise the system under test and to provide user-perceptible occurrences, the video marker insertion into the video data portion 98 (see FIG. 1) preferably includes presenting a visual display aspect as shown by display element 92 on monitor screen 79. The timing aspect of the video marker can be achieved by placing a single detectable marking byte, for example of a predetermined data value, at a predetermined point in the video samples for a frame. In the case of a system under test having an associated display screen 79 as in the embodiment of FIG. 1, the video marker can be caused to coincide with insertion of a visual data pattern that persists for a time from onset of the video marker at a first frame. The preferred form of the display indicia includes some sort of identification of the audio channel being tested, such as “4” in the example. In a surround-sound embodiment, the visible display could relate to expected speaker placement, such as LF (left-front), RF (right-front), etc., which displays are used when applying an audio tone to the named speaker location channel address. This is useful to exercise the system and to display an indication that a particular channel is being tested.

In the example shown in FIG. 1, the video device can be caused to display a geometric mark (such as the circle as shown) and/or to present a numeric of other form of legend identifying the audio channel being tested, such as “4” in the example. At the same time, the audio marker code 105 is caused to occur in the corresponding channel. As a further aspect, the audio marker code can be accompanied by an audible signal such as an audible announcement of a channel identifier, e.g., the spoken word “four” or “left front,” etc.

In FIG. 1, the portion of the test apparatus devoted to inserting audio test codes and video marks into the signal applied to the system under test, is generally shown in the upper block of apparatus 50. The portion of the test apparatus that receives back the output of the system under test is shown in the central block, which contains timing circuits that determine the delay time between receiving the predetermined video and audio markers 103, 105. The lower block of apparatus 50 illustrates an advantageous display configuration for reading out test results.

The audio code mark generator and the video code mark generator in the test apparatus can comprise a stored succession of code values or samples. In an embodiment that includes an audible output, the marker code can accompanied by samples representing a periodic wave to be read out at the required frequency. Similarly, at least one stored color characteristic to be inserted into the video data in conjunction with insertion of the video mark code, for all or a portion of at least one video field or frame. The audio and video code mark generators are operable, upon initiation of a test cycle, to insert data into the program signal at the input 56 to the system 60 under test. The data represents an audio mark 105 for a selected one of the audio channels, and a video mark 103 having a predetermined timing relationship to the inserted audio mark. As mentioned, the relationship can be simultaneous insertion of markers that persist for a brief time such as one second. The audio mark 105 and the video mark 103 are applied to the input 56 for processing by the system 60 under test and appear at the output 58 thereof carrying the effects of such processing. The output of the system under test may be affected by any processing steps that are undertaken so as to differentially delay one of the associated audio and video parts of the signal, or by steps that change or mix audio channel designations.

The test apparatus includes a detector 100 coupleable to an output 58 of the system 60 under test. The detector 100 receives the program signal from the output of the system under test and examines the data for reception of the video marker and the audio marker data. In a digital embodiment, this can involve examining the serial data samples for an expected data pattern.

In an embodiment in which the system under test may have effected a digital to analog conversion and possibly also a subsequent analog to digital conversion before the signal appears that the output, the data pattern may vary naturally from the pattern initially inserted. In that case the audio marker code may entail a pattern of audio signals inserted during muting of the audio channels such that the appearance of any audio signal on the output is the operable detection event, or alternatively the detection should involve a bandwidth specific mathematical process or digital-to-analog and filtering operation to produce the operable triggering signal that the audio marker has been detected.

Preferably, the detection is a digital data pattern, in which case a comparison can be accomplished by shifting the serial data signal through a shift register that is coupled to a set of logic gates (not shown) to produce a triggering output pulse when the passing data matches the previously stored pattern. The same technique (with different data) can be used to detect the onset of the audio sample data and/or the video marker on the output 58 of the system under test.

The timing of the detected video marker and audio marker data are noted and preferably measured by numerically timing the elapsed time between the earlier and later one to be detected in the output of the system under test. Detector portion 100 of test apparatus 50 determines a timing relationship of the data representing the audio marker for at least one of said audio channels versus the video marker, at the output 58 of the system 60 under test, and the relationship includes which of the video marker 103 or the audio marker 105 arrived or commenced to arrive first, as well as the relative delay between the commencement of one and the other.

The test apparatus comprises an output or indicator at the results readout portion 120 whereby the results of the test can be stated in terms of the time by which the audio mark and the video marker were found to lead or lag one another. Assuming that these signals corresponded in time when inserted into the input to the system under test, a detected lead/lag time difference represents an attribute of the system under test that could potentially be regarded as a defect in optimal system performance. The output section 120 preferably includes at least one of an audio signal and visual output display, coupled to the detector portion 100 for presenting a sensed result of said timing relationship.

A specific timing difference can be measured by providing a clock signal from an oscillator and counting the clock pulses between the commencements of the first and second of the audio and video marker signals to arrive. According to a preferred embodiment, the timing is determined by noting the number of samples or groups of samples (such as horizontal video lines) that passed between the onset of the first of the video mark and the audio mark to commence in the output. The count of samples or groups (such as lines) is equated to a particular time increment, and the lead or lag time is provided to a precision of one such increment, e.g., ±1 mS or ±5 mS, etc.

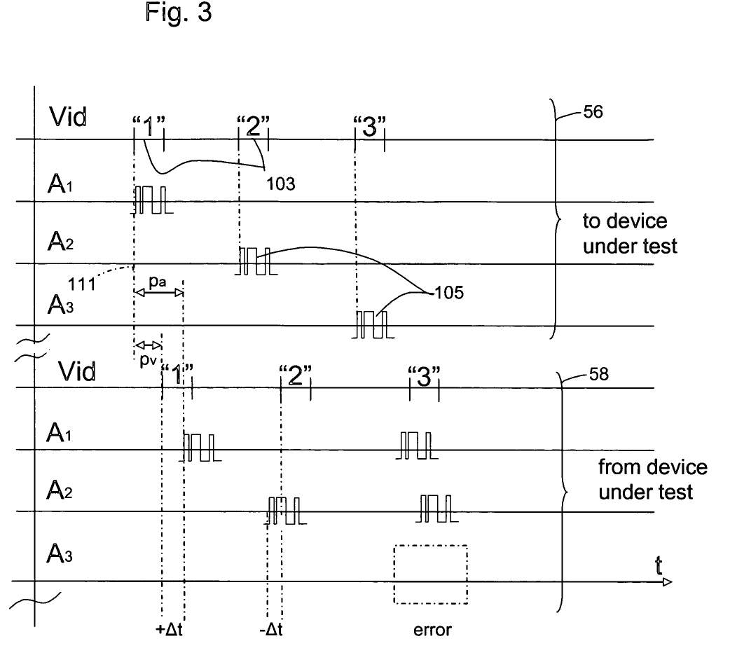

FIG. 3 illustrates some of the particular tests of which the invention is capable. Preferably, there are certain tests that can be selected, for example to apply the audio mark successively to one serial digital audio channel and an next serial digital audio channel, proceeding through a number of audio channels in a sequence. A default selection is to proceed through all the audio channels, one at a time and in numeric order. Thus, one test cycle after another, the video marker is inserted into the video data at a predetermined point in the video frame (e.g., at the beginning) and an audio mark data pattern is inserted into one of the audio channels at a corresponding point. It is not strictly necessary for the video marker to identify the audio channel being tested, but this is an advantageous attribute, particularly if the video marker is also displayed on a video monitor as in FIG. 1.

In the example of FIG. 3, upon commencing the first test, a video marker 103 (“1”) is inserted in the video data and a data pattern 105 representing an audio code or mark, shown schematically as a short pulse train, is inserted at the same time into the audio channel A₁. The serial digital or other similar video data signal is then applied to the input of the system under test. These two signals 103, 105 commence at the same time 111, shown in dot-dash lines (or at least at predetermined known times that can later be resolved).

At some later time, one of the audio mark and the video mark are expected to appear on the output of the system under test. In FIG. 3, the video mark “1” is first to appear, namely after some video propagation delay time pᵥ. In this instance, the audio signal appeared later, after a propagation delay time pₐ, where pₐ>pᵥ. The difference is a positive time difference Δt. Accordingly, in the displayed results as shown, in FIG. 1, the audio lag time is a positive period of time (35 mS in the example shown in FIG. 1). The audio signal in this case emerged on the same channel that was marked at the input.

It is possible that the video marker can lag the appearance of the audio marker. In the second cycle of FIG. 3, the video marker “2” is inserted contemporaneously with an audio marker on channel A₂. In the same manner as described for the first tested channel “1”, the detection portion of the apparatus monitors for the occurrence of the video marker “2” and the audio marker. In this case, the audio marker arrived first. The time difference At is then negative and this result is read out in the display information of the test apparatus.

In the test cycle example “3” shown in FIG. 3, the situation is represented where the video marker “3” is inserted contemporaneously with an audio marker on channel A₃. The detection portion of the test apparatus monitors the output from the device under test and after a delay finds the video marker to occur. However, the audio marker does not appear on channel 3 and in fact is coupled to both of channels A₁ and A₂. Depending on the operation of the device under test, this could potentially represent a correct result, for example where monaural stereo output operation was selected and the monaural input is the channel under test.

In order to detect and indicate either nominal conditions or error conditions in which an inserted audio signal emerges on a different channel, the test apparatus of the invention monitors all the audio channels for the occurrence of the audio marker and appropriately indicates the results, where necessary providing an alarm indicator as suggested by block in FIG. 1.

It is not strictly necessary to check all the audio channels if the expected result is known and operation of that capability is all that is to be checked. Nevertheless, in a preferred arrangement, the detector is operable to test at least one audio channel in addition to said selected one of the audio channels on which the audio marker was applied to the input for processing by the signal under test, so as to test for a channel change when necessary.

Referring again to FIG. 1, the output display 120 coupled to the detector 100 presents a time difference indication and an leading/lagging indicator for showing which of the audio mark and the video mark preceded the other at the output of the system under test. In the illustrated embodiment, a numeric value is used to show the time difference, being positive or negative depending on whether the audio marker lagged the video mark or vice versa. It is also possible to show the order of the two signals and the extent of delay graphically, using a meter or other changeable display. Another example is to shown the delay using a pass/fail indicator, wherein the test indicates pass unless the time difference between receiving the video mark and audio mark are less than a predetermined delay.

It should be noted from FIG. 3 that the device of the invention preferably responds to the difference in the delay between the video marker and the audio marker, as opposed to measuring the overall delay between application of the video marker and the audio marker to the input of the system under test versus noting their respective appearances on the output thereof. Although measuring the total delay time would be possible, it is preferred to measure the difference in delay and typically to ignore any variation in delay time due to buffering and the like if such variations equally affect both the video and the audio.

As discussed, the system under test could have a video monitor 79 to show that the video marker has been inserted, and speakers 83 to play out an audio signal associated with insertion of the audio mark on a particular channel. Although it would be possible to insert corresponding markers into the audio and video data streams in a manner that would not be reproduced at output devices such as the monitor and speakers, it is preferred to use such output devices if available as a way for a person monitoring the testing to note that the devices are being appropriately exercised and are operating nominally. Moreover, the test apparatus of the invention preferably can proceed with test sequences in a semi-autonomous manner, repeated cycling through and checking the differential delay between the inserted audio marker and video marker for each channel, one at a time, and then repeating until the test is discontinued by user input.

In one arrangement, the test apparatus 50 also has certain indications that demonstrate to a user that tests are proceeding. For example, an audio meter display 126 on the test apparatus having a variable indicator for each of the audio channels, and wherein the audio meter display 126 momentarily depicts an audio signal associated with the audio channel mark, when applied to the output and/or when sensed on the audio channel returning from the system under test. Upon commencement of a test (i.e., immediately upon insertion of the video marker and audio marker), or upon receiving the first returning signal (either a leading video marker or upon detected commencement of the audio marker), a moving marker can be activated, and then stopped when the second returning marker is detected, thus providing a movable indication of time delay (as shown by the variable distance over which the moving marker proceeds before stopping) as well as an active and interesting test display. That display can be used together with or in lieu of a numeric readout operated by the detector to show a numeric period of time between detection of the video mark and detection of the audio marker on any one of a number of channels represented on the audio meter.

An audio meter type display 126 having graphic indicators for each tested channel preferably is configured according to the invention to provide for a color signal variation. The displayed color can be varied by the detector as a signaling aspect. For example, a color indicated on the audio meter display for a channel can be changed when an audio marker is sensed on an unexpected channel (i.e., a channel that differs from a channel on which the audio marker was applied at the input) or when no audio marker is detected. Different signaling possibilities are presented by including the alarm indicator 124, the meter indicator 126 and by providing multiple color selections by which combinations of colors signal different situations of the type discussed.

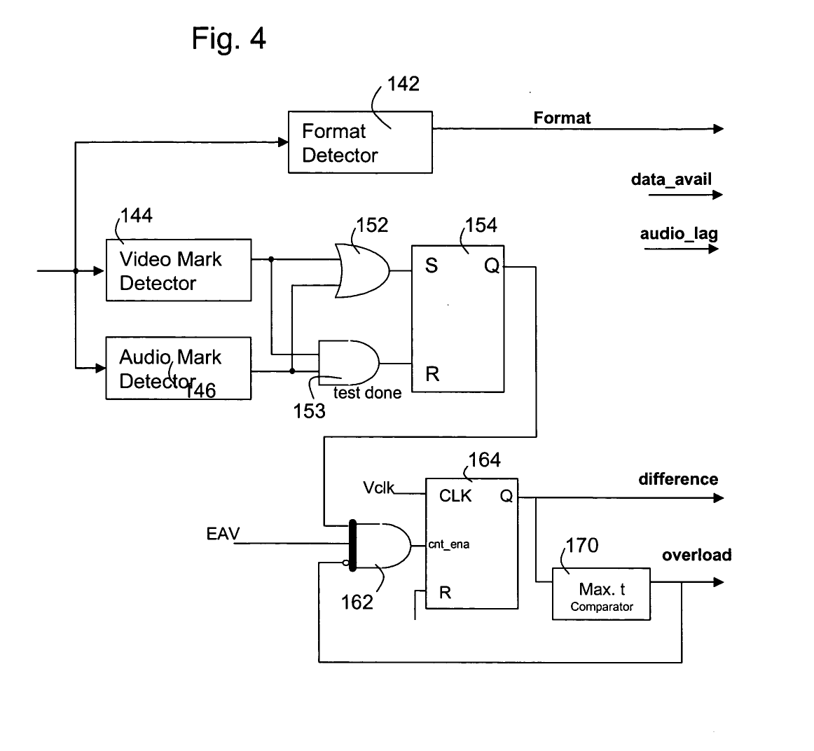

FIG. 4 illustrates a logic diagram showing how the invention can be embodied with relatively few gates and flip-flops. A format detector 142 preferably is provided to distinguish, for example, between NTSC and PAL signals, because the timing of video lines differs between the two formats. A video mark detector 144 and an audio marker detector 146 are coupled to the output of the system under test and can contain digital comparators as mentioned above, operable to produce a true output when their respective codes appear in the signal. The video and audio mark detectors are coupled to the inputs of an OR gate 152 and an AND gate 153, the outputs of which are coupled to the set and reset inputs of a S/R flip-flop 154. The Q output of register or flip-flop 154 is set true upon the arrival of the first of the audio and video mark signals to arrive. The Q output stays true until the second of the mark signals arrives. This produces a pulse on the Q output of the flip-flop, having a pulse width corresponding to the time delay between first sensing of the video mark and the audio mark. This pulse width is timed to determine the differential delay that is displayed on output display 120. Another flip-flop (not shown) can be set or reset depending on which of the two signals is received first, providing an “audio_lag” output that is true or not true depending on whether or not the video is received before the audio mark.

The output of the variable width pulse on the Q output of flip-flop 154 (that becomes longer or shorter with the time between receiving the two signals 103, 105) is one input to an AND gate 162, the other inputs being an EAV enable signal and a timeout blocking signal from a maximum time comparator 170. The output of gate 162 enables a counter 164 to count transitions on a clock signal V Clk that provides a time base. The output of the counter 164 represents the time delay between the commencement of the first and second of the markers to be received. The time base signal V Clk can be a clock oscillator signal or another signal having a known time period, such as the horizontal line rate, in either case the count convertible into a known delay time. If the time base is the horizontal line rate or another signal that is different for different signal formats, the format detector 142 can be used to select the correct conversion ratio of counts to time increments. The converted value, for example stated in milliseconds, is displayed on the test apparatus output 120.

It is possible, that the signal on the audio channel under test may never be received, as in the example of channel A₃ in FIG. 3. This situation is detected by a comparator 170, labeled “Max. t Comparator.” The comparator 170 produces an “overload” signal at some count value that is sufficiently long to give up waiting for the latter of the video mark and the audio mark to occur. The occurrence of an output signal on comparator 170 concludes the test on the basis that the second marker has been “lost.” The lack of signal, which might be considered an unsuccessful test except that loss of a signal is in itself a success as a test result, is indicated on the test apparatus output display. Generally this situation occurs when the audio signal does not occur, as opposed to losing the video marker; however either signal could conceivably be lost.

In the preferred arrangement, the logic functions are served by an appropriately programmed field programmed logic array. It should be apparent that the same functions could be met using other specific logic devices or by providing similar inputs to a digital processor or controller that is programmed in a manner that resembles operation of the logic elements. There are also various alternative logic implementations that can achieve the same results.

The invention has been described with respect to certain exemplary hardware elements but can also be considered a method. The inventive method for testing a digital video processing system, which system is operable to process video samples and embedded audio samples, includes several steps as follows. Similarly, the invention can be considered a programmed device that accomplishes these steps, and/or a data carrier that contains programming for accomplishing the steps. The steps include providing a digital signal in a format providing for a succession of digitized audio samples, preferably both video and audio and involving plural audio channels. At least one audio marker is inserted into the digital signal to mark a channel. Preferably, a video marker and an audio marker having a predetermined timing relationship are inserted at the same time or at times having such predetermined relationship. The audio marker is associated with a predetermined one of a plurality of audio channels. The digital signal is then processed through a signal processing device having an arbitrary effect on the digital signal and in one or more inserted markers. The invention comprises sensing for the audio marker on the correct one of the multiple channels. Preferably the invention also comprises sensing for the audio marker on other channels from the one on which the marker was inserted.

In the exemplary embodiments, a video marker is simultaneously inserted into the active video data at the same time that an audio marker is inserted in a test channel. At the output of the video processing device, the difference is timed between the appearance of the audio marker and the video marker at the output of the video processing device. The invention comprises reading out difference and the lead/lag order, while and preferably also testing and displaying the extent of channel integrity, i.e., indicating any mismatch between channel addresses at the input and output of the system under test.

The predetermined timing relationship can be achieved by placing the audio marker at a predetermined timing position associated with a marked frame of video data. In one arrangement, the timing marker is associated with a predetermined horizontal line of video data and the audio marker is inserted as a set of audio data samples associated with the horizontal line. When receiving video information and extracting the audio data, the order in which the audio and video markers are received is noted as a determination of whether the audio was found to be leading or lagging the video marker and vice versa. This determination is displayed by a graphic indicator, data value, or other indication. Also displayed is a numeric indicator of the time difference between commencement of the received audio marker signal and the received video marker signal, thus providing a differential timing measurement. This differential timing measurement can be independent of buffering delay or other delay affecting both the video marker and the audio marker data.

In one embodiment, the differential timing is determined by counting a related clock signal such as the number of horizontal lines of video data passing between the reception of the video marker and the audio mark, or vice versa. The number of lines can then be related to a time measurement with regard, if necessary, to possible differences in line rate due to the format of the video signal, e.g., serial digital in timing and organization intended for PAL or NTSC end receiver devices.

A plurality of accessible audio channels, in addition to a predetermined tested target channel on which an audio test mark signal is inserted, can be subject to testing so as to find or identify or test the operation of various possible couplings between channels. This function is facilitated by applying the audio marker successively to each of the plurality of accessible channels in turn, as the predetermined one of the audio channels being tested, and then on the receiving end, testing for the received audio marker on each of the plurality of accessible channels for said predetermined one and also for each other channel in the plurality. Such testing or monitoring of accessible channels in anticipation of the appearance of the audio mark, can proceed for a predetermined time before concluding that the signal will not appear on the associated channel. Appropriate time readouts, alarms and error condition indicators can be employed as outlined hereinabove.

The invention having been disclosed in connection with the foregoing preferred arrangements, variations will now be apparent, and should be considered encompassed within the scope and spirit of the invention.

1. An apparatus for assessing operation of a system under test, the system being operable to process at least one video signal and a plurality of audio signals corresponding to audio channels, the apparatus comprising:
a source of an audio-video program signal in a digital format having successive samples of video data and accompanying audio data for plural audio channels, the source being coupleable to an input of the system under test;
an audio mark generator and a video marker generator, wherein the audio mark generator and the video marker generator respectively produce audio and video data for processing through the system under test;
wherein the audio mark generator and the video mark generator are operable upon initiation of a test cycle to insert data into the program signal at the input to the system under test, the data representing an audio mark for a selected one of the audio channels and a video marker having a predetermined timing relationship, said audio mark and said video marker being thereby applied as the input for processing by the system under text;
a detector coupleable to an output of the system under test, wherein the detector is operable to receive the program signal, and to sense a timing relationship of the data representing the audio mark for at least one of said audio channels versus the video marker, at the output of the system under test; and,
at least one of an audio and visual output coupled to the detector for presenting a sensed result of said timing relationship.

2. The apparatus of claim 1, wherein the audio mark generator and the video mark generator are configured to apply the audio mark successively to one serial digital audio channel and an next serial digital audio channel, proceeding through said audio channels.

3. The apparatus of claim 1, wherein the detector is operable to test at least one audio channel in addition to said selected one of the audio channels on which the audio mark was applied to the input for processing by the signal under test.

4. The apparatus of claim 1, wherein the output coupled to the detector presents a time difference and an leading/lagging indicator for showing which of the audio mark and the video mark preceded the other at the output of the system under test.

5. The apparatus of claim 3, wherein the detector is operable to test each of said plurality of audio channels for the audio mark.

6. The apparatus of claim 1, the output coupled to the detector comprises an audio meter display having a variable indicator for each of the audio channels, and wherein the audio meter display momentarily depicts the audio mark when applied to and sensed on the audio channel.

7. The apparatus of claim 6, further comprising a numeric readout operated by the detector to show a numeric period of time between detection of the video mark and detection of the audio mark on any one of a number of channels represented on the audio meter.

8. The apparatus of claim 6, wherein the audio meter is configured to provide for a variation in display readout upon detection of a mismatch wherein the audio mark is sensed on a channel that differs from a channel on which the audio mark was applied at the input.

9. The apparatus of claim 1, wherein at least one of the video mark and the audio mark is applied in a nominal manner whereby one of a video receiver system coupled to the system under test shows a mark visibly in a video display and an audio speaker coupled to the system under test produces an audio mark corresponding to the output of system under test.

10. A method for testing a digital video processing system operable to process video samples and embedded audio samples, comprising the steps of:
providing a digital signal in a format providing for a succession of digitized audio and video samples;
inserting into the digital signal a video marker and at least one audio marker, the video marker and the audio marker having a predetermined timing relationship and the audio marker being associated with a predetermined one of a plurality of audio channels;
processing the digital signal through a video processing device having an arbitrary effect on at least one of an audio and a video portion of the digital signal;
sensing for the video marker an the audio marker at an output of the video processing device;
timing a difference between appearance of the audio marker and the video marker at said output of the video processing device; and,
reading out said difference.

11. The method of claim 10, wherein the predetermined timing relationship is achieved by placing the audio marker at a predetermined timing position associated with a marked frame of video data.

12. The method of claim 10, further comprising reading out an order of which of the audio and video markers was found to be leading and lagging the other of the audio and video markers.

13. The method of claim 10, further comprising testing for received audio on a plurality of accessible channels in addition to the predetermined one of the audio channels.

14. The method of claim 13, comprising applying the audio marker successively to each of the plurality of accessible channels in turn, for purpose of identification of said predetermined one of the audio channels, and further comprising testing for the received audio marker on each of the plurality of accessible channels in addition to said predetermined one.

15. A method for testing a digital processing system operable to process audio signals for multiple channels, comprising the steps of:
providing a digital signal in a format providing for digitized audio samples for said multiple channels;
inserting into the digital signal at least one audio marker so as to distinguish a subset of at least one of said multiple channels from at least one other of the multiple channels by virtue of said audio being inserted into the subset and not into said at least one other;
processing the digital signal through a signal processing device having an arbitrary effect on an audio portion of the digital signal; and,
sensing for the audio marker at an output of the signal processing device corresponding to the subset distinguished by said audio marker being inserted therein, and further comprising sensing for the audio marker on at least one other of the multiple channels so as to determine a mismatch in channel integrity through said signal processing device.

16. The method of claim 15, wherein the digital signal is a video signal having an audio portion and a video portion, and comprising also inserting a marker into the video portion with a predetermined timing relationship to said audio marker, and further comprising sensing for relative timing effects caused by the signal processing device, by monitoring for changes relative to the predetermined timing relationship at an output of the signal processing device.

17. The method of claim 16, wherein the marker in the video portion is inserted into active video and includes an indicia that is visible in playback of the video portion on a monitor device.

18. The method of claim 16, further comprising exercising the audio and video portions by inserting at least one of active audio and video signals that are discernible in playback of the audio and video portions.

19. The method of claim 18, further comprising marking and exercising each of the multiple channels by inserting a marker therein, proceeding one at a time.
